(19) United States
(12) Patent Application Publication
(10) Pub. No.: US 2026/0048486 A1
(43) Pub. Date: Feb. 19, 2026

(54) SOCKET STRUCTURE FOR HAND OPERATED TOOL

(71) Applicant: Chia-Kuan Liao, Taichung City (TW)

(72) Inventor: Chia-Kuan Liao, Taichung City (TW)

(21) Appl. No.: 18/805,466

(22) Filed: Aug. 14, 2024

(51) Int. Cl. B25B 13/06; B25B 13/04; B25B 13/08; B25B 13/46

(52) U.S. Cl. CPC B25B 13/065; B25B 13/04; B25B 13/08; B25B 13/463

(57) ABSTRACT

A socket structure includes a main body provided with a mounting element. The mounting element includes six drive portions and six receiving portions. Each of the six drive portions includes a first face and a second face. The first face and the second face have an intersection provided with a first intersecting line. The first face and the second face intersect at a straight line. Each of the six receiving portions is an arcuate concave face. In a two-dimensional view, the mounting element has an axis provided with a first center, a first circle, a first hexagon, a first vertical line, six first angled corners, and a first distance, and the first center constructs a second circle, a second hexagon, six second angled corners, a second distance, and a first angle.

### BACKGROUND OF THE INVENTION

### Field of the Invention

The present invention relates to an engaging mechanism or a socket and, more particularly, to a socket structure for a hand operated tool.

### Description of the Related Art

A conventional socket structure was disclosed in the U.S. Publication No. 2007/0125204, and comprises a socket 20 having an engaging hole 22, six grooves 23, and six stop ribs 24.

However, such a conventional socket structure has the following disadvantages.

1. When the socket 20 drives the screw head 40, the stop ribs 24 are locked on the six sides of the screw head 40, to rotate the screw head 40. The stop ribs 24 protrude in the engaging hole 22 to an extent, and a large interval is defined between the groove 23 of the engaging hole 22 and the angled corner of the screw head 40 so that the engaging hole 22 cannot easily rub the angled corner of the screw head 40. But, the socket 20 needs to have a determined thickness to keep the rotation force and torque, so that the outer diameter of the socket 20 is increased due to projection of the stop ribs 24.

2. Each of the stop ribs 24 has a sharp pointed shape so that the rotation torque is not large enough. Thus, the screw head 40 is easily worn out or chamfered by the stop ribs 24 during a period of time.

3. When the socket 20 is used to rotate the screw head 40, the stop ribs 24 engage the screw head 40 successively and easily cause a serration on the screw head 40.

### BRIEF SUMMARY OF THE INVENTION

The primary objective of the present invention is to provide a socket structure that is available for driving a screw member that is worn out or rounded.

In accordance with the present invention, there is provided a socket structure comprising a main body provided with a mounting element. The mounting element includes six drive portions and six receiving portions. Each of the six drive portions includes a first face and a second face. The first face and the second face have an intersection provided with a first intersecting line. The first face and the second face intersect at a straight line. Each of the six receiving portions is an arcuate concave face. In a two-dimensional view, the mounting element has an axis provided with a first center, a first circle, a first hexagon, a first vertical line, six first angled corners, and a first distance, and the first center constructs a second circle, a second hexagon, six second angled corners, a second distance, and a first angle.

According to the primary advantages of the present invention, the main body is rotated clockwise to screw the screw member by a large contact area of the second face. Alternatively, the main body is rotated counterclockwise to unscrew the screw member by a large contact area of the first face. Alternatively, the main body is rotated counterclockwise to unscrew the worn screw member by a force concentration of the first intersecting line. Thus, the mounting element has three rotational modes to drive and rotate the screw member exactly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a socket structure in accordance with the preferred embodiment of the present invention.

FIG. 2 is a front view of the socket structure in accordance with the preferred embodiment of the present invention.

FIG. 3 is a schematic front view of the socket structure in accordance with the preferred embodiment of the present invention.

FIG. 4 is a front view of a first operation state of the socket structure in accordance with the preferred embodiment of the present invention.

FIG. 5 is a front view of a second operation state of the socket structure in accordance with the preferred embodiment of the present invention.

FIG. 6 is a front view of a third operation state of the socket structure in accordance with the preferred embodiment of the present invention.

FIG. 7 is a perspective view of a socket structure in accordance with the second preferred embodiment of the present invention.

FIG. 8 is a perspective view of a socket structure in accordance with the third preferred embodiment of the present invention.

FIG. 9 is a front view of a socket structure in accordance with the fourth preferred embodiment of the present invention.

FIG. 10 is a front view of a socket structure in accordance with the fifth preferred embodiment of the present invention.

FIG. 11 is a front view of a socket structure in accordance with the sixth preferred embodiment of the present invention.

FIG. 12 is a front view of a socket structure in accordance with the seventh preferred embodiment of the present invention.

FIG. 13 is a front view of a socket structure in accordance with the eighth preferred embodiment of the present invention.

FIG. 14 is a front view of a socket structure in accordance with the ninth preferred embodiment of the present invention.

FIG. 15 is a front view of a socket structure in accordance with the tenth preferred embodiment of the present invention.

FIG. 16 is a front view of a socket structure in accordance with the eleventh preferred embodiment of the present invention.

FIG. 17 is a front view of a socket structure in accordance with the twelfth preferred embodiment of the present invention.

### DETAILED DESCRIPTION OF THE INVENTION

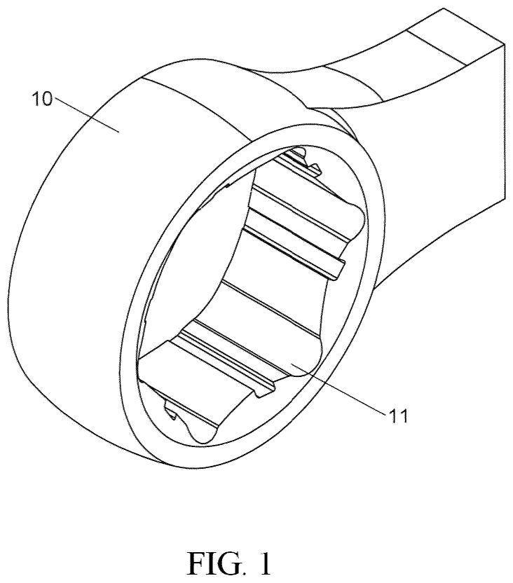

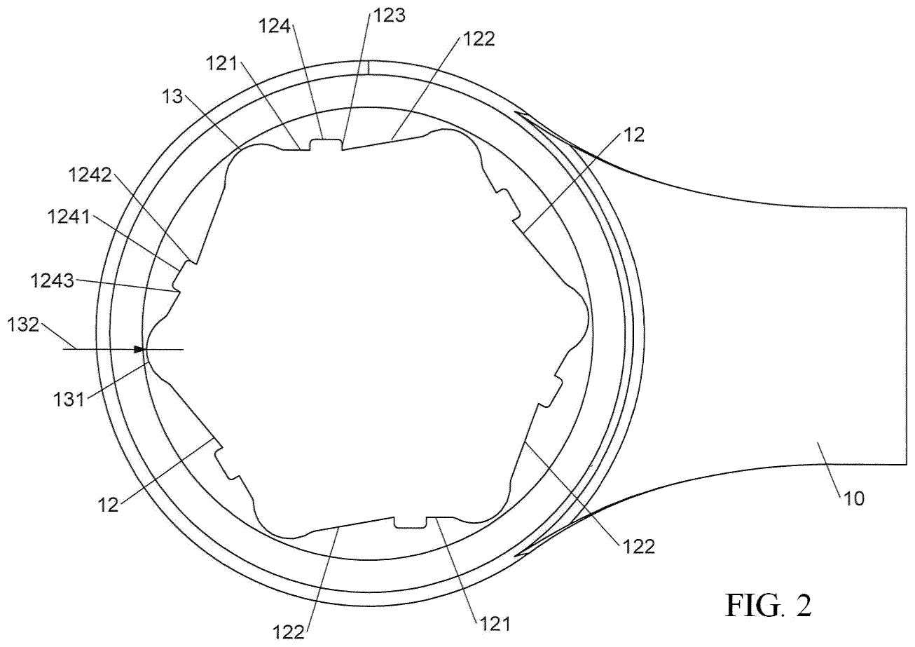

Referring to the drawings and initially to FIGS. 1-3, a socket structure for a hand operated tool in accordance with the preferred embodiment of the present invention comprises a main body 10. The main body 10 is provided with a mounting element 11. The mounting element 11 includes six drive portions 12 and six receiving portions 13. The six drive portions 12 and the six receiving portions 13 are arranged alternately and annularly. The main body 10 is a box end wrench or a socket (or an engaging member) of a hand operated tool.

Each of the six drive portions 12 includes a first face 121 and a second face 122. Each of the first face 121 and the second face 122 has a planar shape. The first face 121 and the second face 122 have an intersection provided with a first intersecting line 123. The first face 121 and the second face 122 intersect at a straight line. Each of the six drive portions 12 is provided with a groove 124 disposed on the first face 121. The groove 124 has a first side 1241 and two second sides 1242. The first side 1241 and the two second sides 1242 form a U-shaped opening. Each of the first side 1241 and the two second sides 1242 has a planar shape. The first side 1241 is provided on a bottom of the groove 124. The two second sides 1242 are at two sides of the first side 1241. One of the two second sides 1242 coincides with the first intersecting line 123. The groove 124 and the first side 1241 have an intersection provided with a second intersecting line 1243. Thus, the groove 124 and each of the six drive portions 12 intersect at the first intersecting line 123 and the second intersecting line 1243. The second intersecting line 1243 is parallel with the first intersecting line 123.

Each of the six receiving portions 13 is an arcuate concave face. Each of the six receiving portions 13 is arranged between the first face 121 of one of the six drive portions 12 and the second face 122 of another one of the six drive portions 12. Each of the six receiving portions 13 is formed with a first arc 131. The first arc 131 is not tangent to the first face 121 and the second face 122. The first arc 131 has a first radius 132.

In a two-dimensional view, the mounting element 11 has an axis provided with a first center 14 which constructs a first circle 141. The first face 121 of each of the six drive portions 12 is tangent to the first circle 141. The first circle 141 forms a first hexagon 142 having six sides. The first face 121 of each of the six drive portions 12 coincides with each of the six sides of the first hexagon 142. The first center 14 is provided with a first vertical line 143. The first face 121, the groove 124, and the first intersecting line 123 are arranged at a first side of the first vertical line 143, and the second face 122 is arranged at a second side of the first vertical line 143. The first face 121 is perpendicular to the first vertical line 143. The first hexagon 142 has six first angled corners 144. The first arc 131 of each of the six receiving portions 13 is situated outside of each of the six first angled corners 144. A first distance 145 is defined between two of the six sides of the first hexagon 142.

The first radius 132 has a value one fifth (⅕) of that of the first distance 145.

In a two-dimensional view, the first center 14 constructs a second circle 146 having a diameter slightly more than that of the first circle 141. The second face 122 of each of the six drive portions 12 is tangent to the second circle 146. The second circle 146 forms a second hexagon 147 having six sides. The second face 122 of each of the six drive portions 12 coincides with each of the six sides of the second hexagon 147. The second hexagon 147 is larger than the first hexagon 142. The second hexagon 147 has six second angled corners 148. The first arc 131 of each of the six receiving portions 13 is situated outside of each of the second angled corners 148. Thus, each of the six first angled corners 144 and each of the second angled corners 148 are disposed in the first arc 131 of each of the six receiving portions 13. A second distance 149 is defined between two of the six sides of the second hexagon 147. The second distance 149 is more than the first distance 145. A first angle 1491 is defined between each of the six sides of the first hexagon 142 and each of the six sides of the second hexagon 147. The first angle 1491 is ranged between 5° and 25° or ranged between 5° and 15°. The first angle 1491 is equal to 10°.

According to a German DIN standard specification, the first distance 145 is equal to or close to an integer value of a specification of the mounting element 11. If the specification of the mounting element 11 is 17 MM, the first distance 145 is equal to or close to 17 MM. According to the German DIN standard specification, the second distance 149 is ranged between an upper limit (or the maximum) and a lower limit (or the minimum) of the specification of the mounting element 11. If the specification of the mounting element 11 is 17 MM, the second distance 149 is ranged between 17.05 MM and 17.30 MM, and if the specification of the mounting element 11 is 19 MM, the second distance 149 is ranged between 19.06 MM and 19.36 MM.

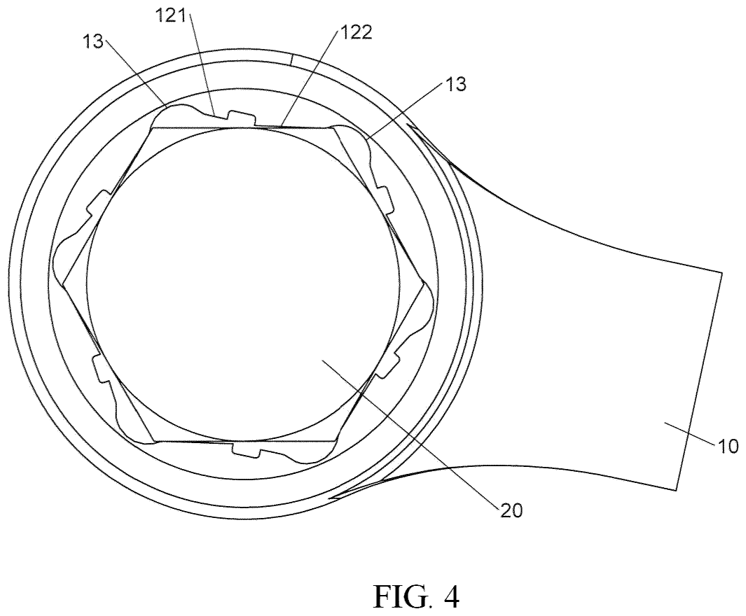

Referring to FIG. 4 with reference to FIGS. 1-3, the main body 10 is used to operate and rotate a screw member 20 having six sides and six angled corners. When the main body 10 is rotated clockwise to drive the screw member 20, the second face 122 of each of the six drive portions 12 presses each of the six sides of the screw member 20, and a space (or an interval) is defined between the first face 121 of each of the six drive portions 12 and each of the six sides of the screw member 20. At the same time, each of the six angled corners of the screw member 20 is received in each of the six receiving portions 13, so that when the mounting element 11 of the main body 10 is rotated clockwise to drive the screw member 20, each of the six receiving portions 13 is spaced from each of the six angled corners of the screw member 20, to prevent each of the six angled corners of the screw member 20 from being worn by the mounting element 11.

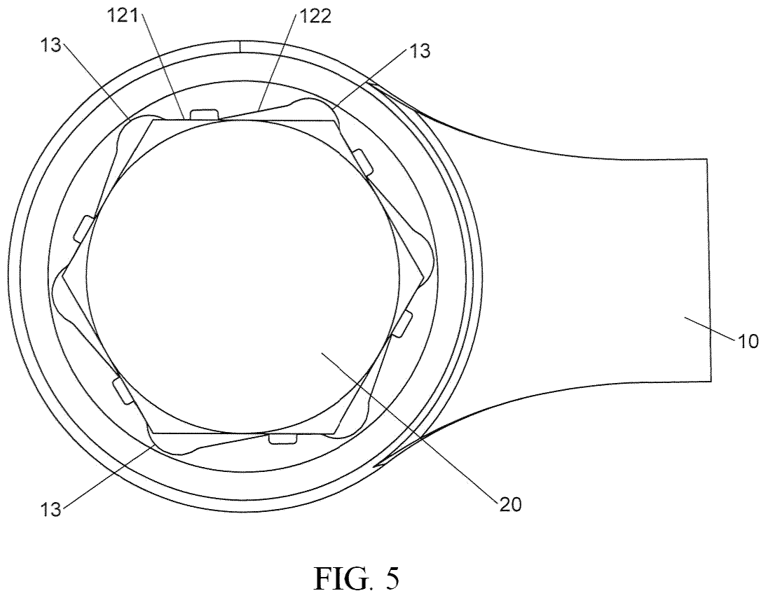

Referring to FIG. 5 with reference to FIGS. 1-3, when the main body 10 is rotated counterclockwise to drive the screw member 20, the first face 121 of each of the six drive portions 12 presses each of the six sides of the screw member 20, and a space (or an interval) is defined between the second face 122 of each of the six drive portions 12 and each of the six sides of the screw member 20. At the same time, each of the six angled corners of the screw member 20 is received in each of the six receiving portions 13, so that when the mounting element 11 of the main body 10 is rotated counterclockwise to drive the screw member 20, each of the six receiving portions 13 is spaced from each of the six angled corners of the screw member 20, to prevent each of the six angled corners of the screw member 20 from being worn by the mounting element 11.

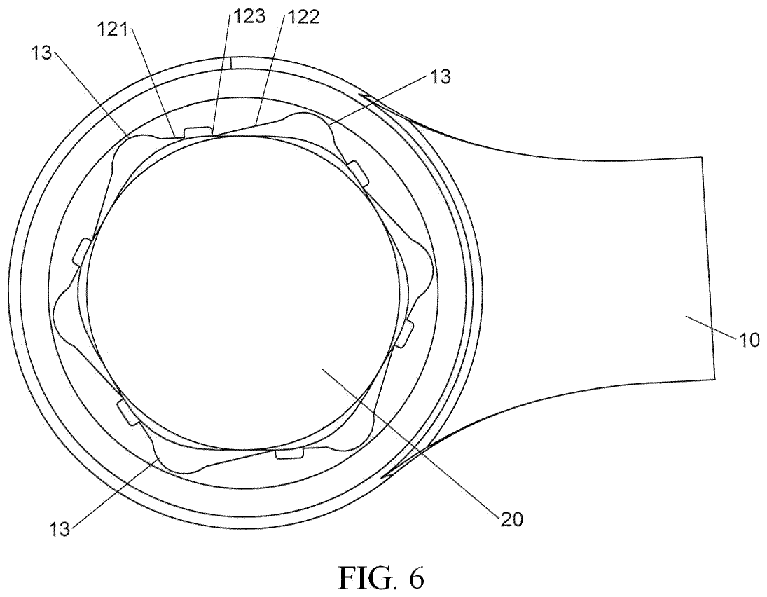

Referring to FIG. 6 with reference to FIGS. 1-3, the screw member 20 is worn out and rounded. When the main body 10 is rotated counterclockwise to drive the screw member 20, the first intersecting line 123 of each of the six drive portions 12 presses each of the six sides of the screw member 20. In such a manner, the first intersecting line 123 of each of the six drive portions 12 has a line contact with each of the six sides of the screw member 20 so that the first intersecting line 123 of each of the six drive portions 12 concentrates the force point to drive and rotate each of the six worn sides of the screw member 20 exactly and easily. Thus, the mounting element 11 is used to drive and rotate the screw member 20 that has been worn out.

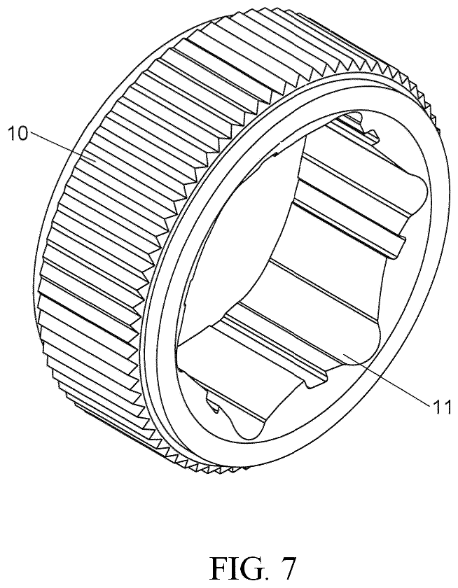

Referring to FIG. 7, the main body 10 is a ratchet wheel structure pivotally mounted on a ratchet wrench.

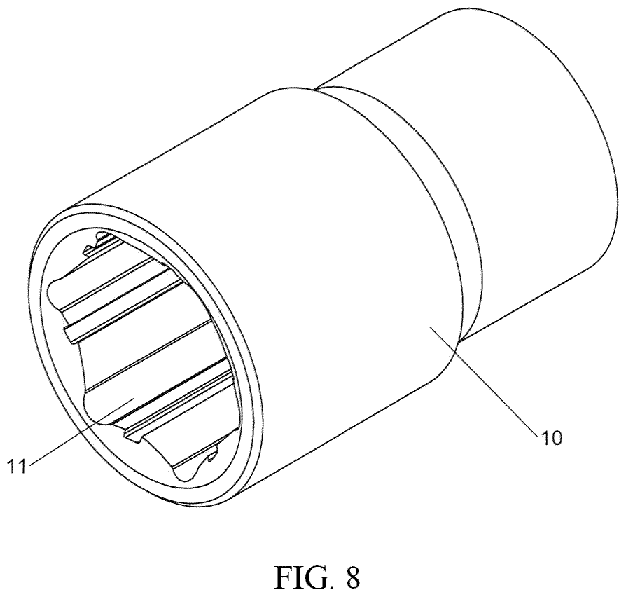

Referring to FIG. 8, the main body 10 is a socket.

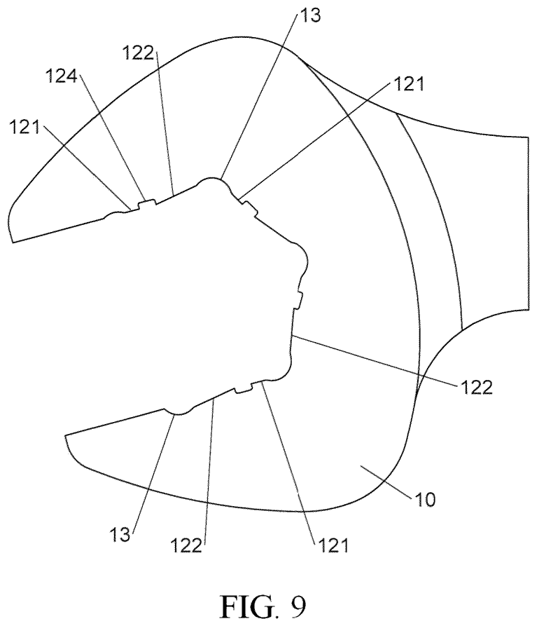

Referring to FIG. 9, the main body 10 is an open wrench having four drive portions 12 and four receiving portions 13. The four drive portions 12 and the four receiving portions 13 are formed on four faces of the mounting element 11.

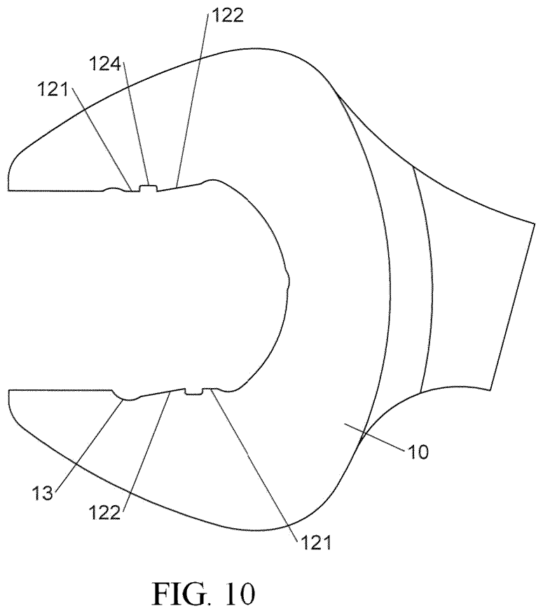

Referring to FIG. 10, the main body 10 is an open wrench having two drive portions 12 and two receiving portions 13. The two drive portions 12 and the two receiving portions 13 are formed on two faces of the mounting element 11.

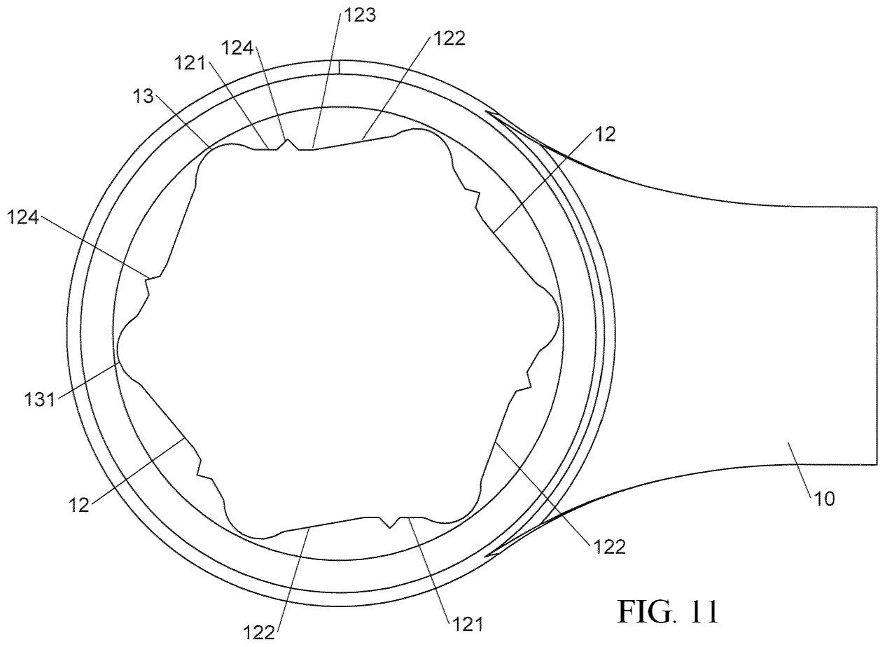

Referring to FIG. 11, the groove 124 has a triangular shape or the groove 124 is an isosceles triangle.

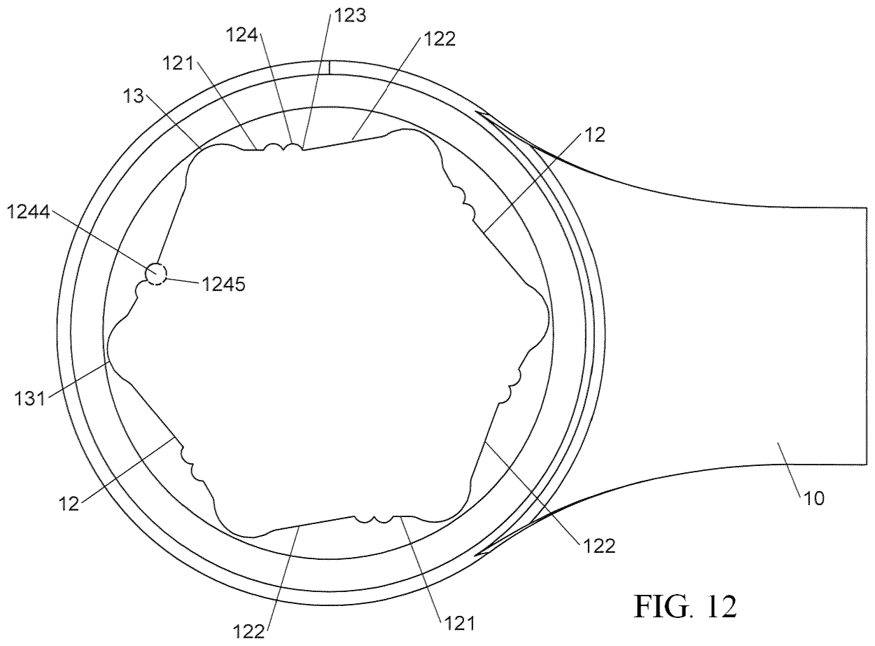

Referring to FIG. 12, each of the six drive portions 12 is provided with two grooves 124 connecting each other. Each of the two grooves 124 has a first axis 1244. The first axis 1244 has a first diameter 1245. Similarly, each of the six drive portions 12 is provided with multiple grooves 124 connecting each other.

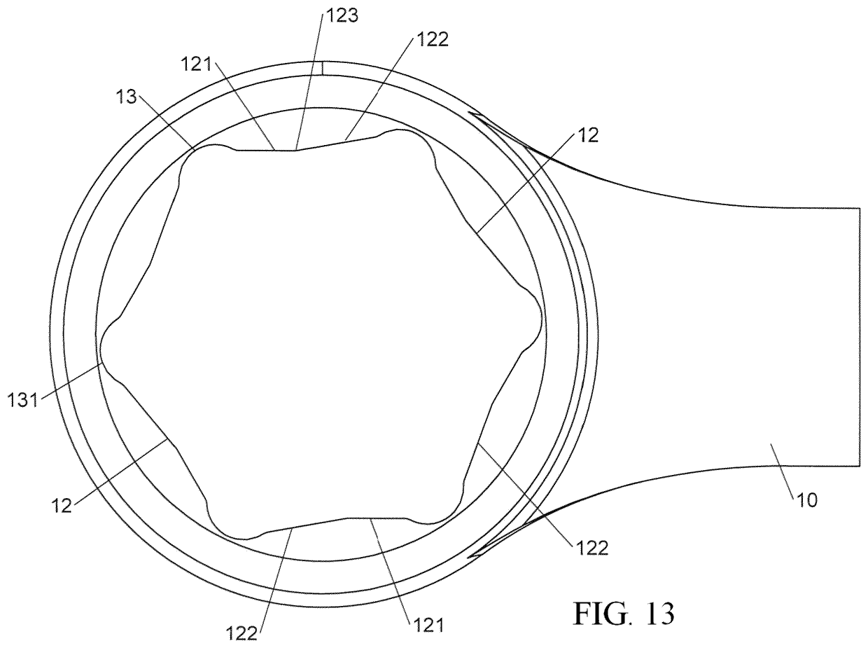

Referring to FIG. 13, the first intersecting line 123 of each of the six drive portions 12 is formed between the first face 121 and the second face 122.

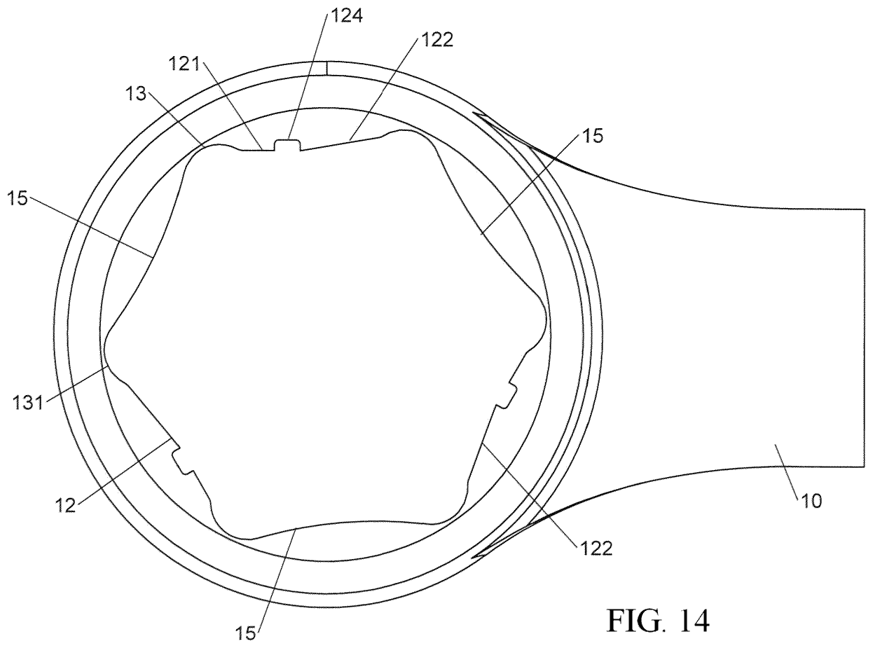

Referring to FIG. 14, the mounting element 11 includes three drive portions 12, six receiving portions 13, and three convex portions 15. The three drive portions 12 and the three convex portions 15 are arranged alternately and annularly. The three drive portions 12, the six receiving portions 13, and the three convex portions 15 are arranged alternately and annularly.

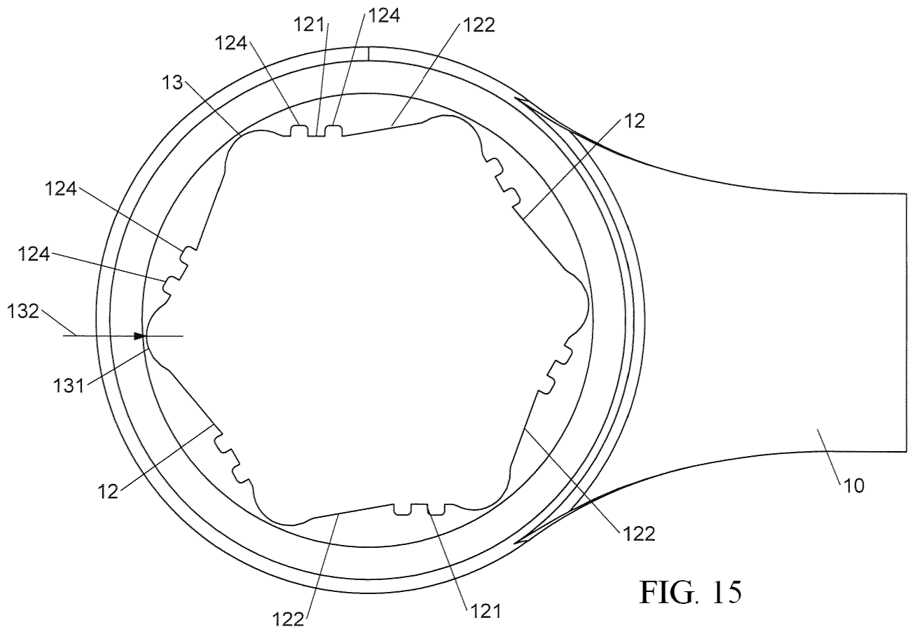

Referring to FIG. 15, each of the six drive portions 12 is provided with two or multiple grooves 124 spaced from each other.

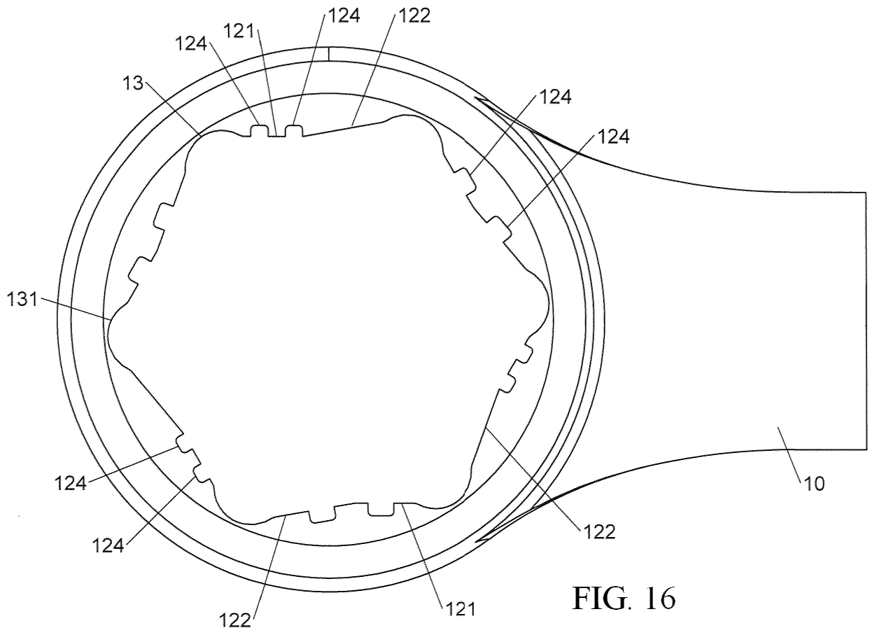

Referring to FIG. 16, each of the six drive portions 12 is provided with two grooves 124 spaced from each other. In three of the six drive portions 12, the two grooves 124 are formed on the first face 121. In the other three of the six drive portions 12, one of the two grooves 124 is formed on the first face 121, and the other one of the two grooves 124 is formed on the second face 122.

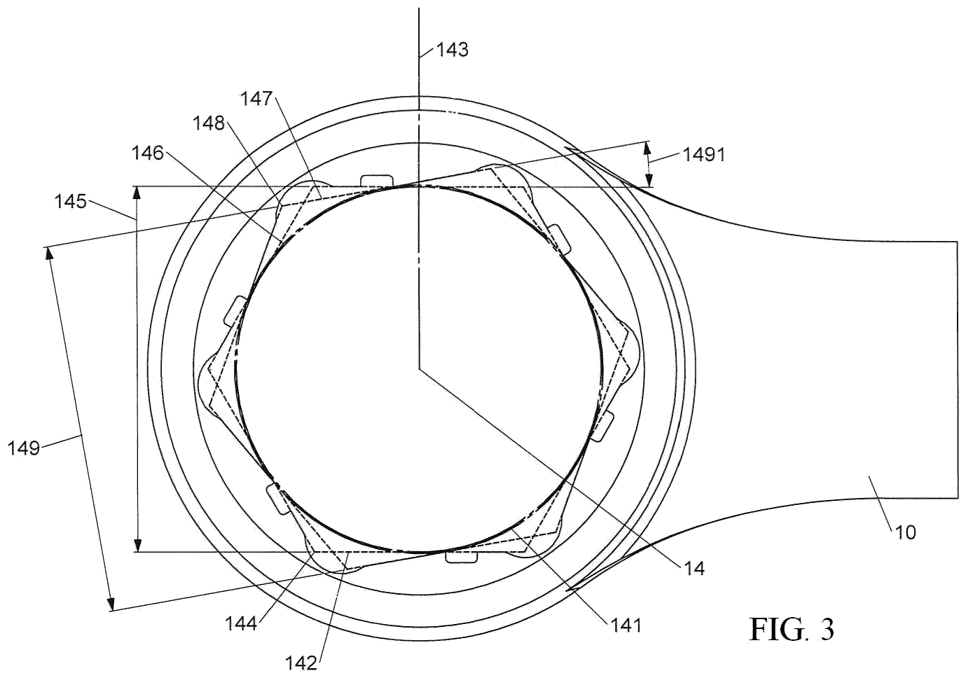

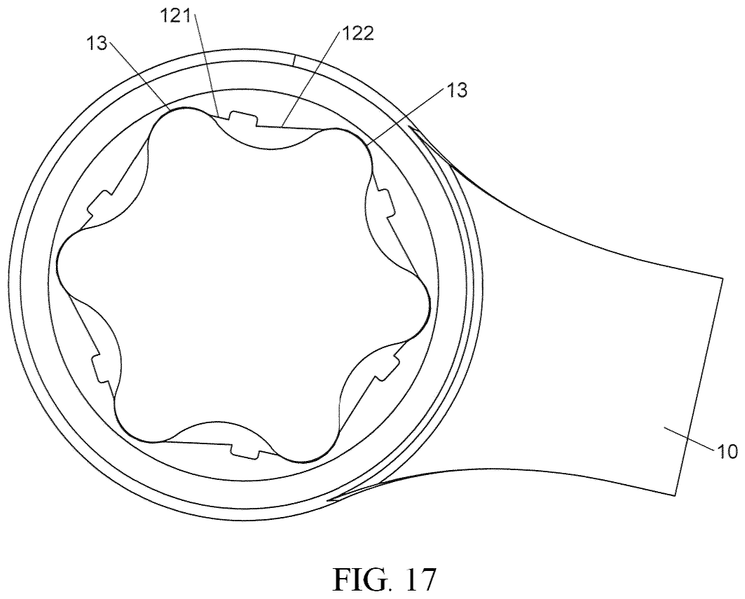

Referring to FIG. 17, the six receiving portions 13 are used to receive or accommodate six lugs 13 of a star-shaped screw member whose structure was disclosed in FIG. 3 of the U.S. Pat. No. 3,584,667.

Accordingly, the socket structure of the present invention has the following advantages.

1. With reference to FIG. 4, when the main body 10 is rotated clockwise to drive the screw member 20, the second face 122 of each of the six drive portions 12 provides a primary force. Thus, the second face 122 of each of the six drive portions 12 has the maximum contact area for driving the screw member 20, to prevent the six sides of the screw member 20 from being worn out.

2. With reference to FIG. 5, when the main body 10 is rotated counterclockwise to drive the screw member 20, the first face 121 of each of the six drive portions 12 provides a primary force. Thus, the first face 121 of each of the six drive portions 12 has a larger contact area for driving the screw member 20, to prevent the six sides of the screw member 20 from being worn out.

3. With reference to FIG. 6, when the main body 10 is rotated to drive the screw member 20 whose six sides are worn out and rounded, the first intersecting line 123 of each of the six drive portions 12 presses and locks each of the six sides of the screw member 20. In such a manner, the first intersecting line 123 of each of the six drive portions 12 has a line contact with each of the six sides of the screw member 20 so that the first intersecting line 123 of each of the six drive portions 12 concentrates the force to drive and rotate each of the six worn sides of the screw member 20 exactly and easily. With reference to FIG. 3, the first intersecting line 123 is very close to the first vertical line 143. Thus, by provision of the first intersecting line 123 of each of the six drive portions 12, the mounting element 11 is used to drive and rotate the screw member 20 that has been worn out seriously.

4. The main body 10 is rotated clockwise to screw the screw member 20 by a large contact area of the second face 122. Alternatively, the main body 10 is rotated counterclockwise to unscrew the screw member 20 by a large contact area of the first face 121. Alternatively, the main body 10 is rotated counterclockwise to unscrew the worn screw member 20 by a force concentration of the first intersecting line 123. Thus, the mounting element 11 has three rotational modes to drive and rotate the screw member 20 exactly.

5. The second distance 149 satisfies the standard specification so that when the second face 122 of each of the six drive portions 12 is used to drive the screw member 20, the socket structure has an operational effect the same as that of the conventional socket. The conventional socket usually has two standard specifications. For example, the specification 17 includes two standard specifications of 17.04 MM and 17.31 MM. Thus, the second distance 149 satisfies the standard specification without having to make a standard specification.

6. Each of the six receiving portions 13 is an arcuate concave face. Each of the six receiving portions 13 is arranged between the first face 121 of one of the six drive portions 12 and the second face 122 of another one of the six drive portions 12. Each of the six receiving portions 13 is formed with the first arc 131 that is not tangent to the first face 121 and the second face 122. Thus, when the main body 10 is rotated to drive the screw member 20, each of the six angled corners of the screw member 20 is received in each of the six receiving portions 13, thereby preventing each of the six angled corners of the screw member 20 from being worn out.

7. Each of the first face 121 and the second face 122 has a planar shape, so that the first face 121 and the second face 122 will not cause a bite mark (or serration) on the screw member 20 during rotation.

8. If the specification of the mounting element 11 is 17 MM, the first distance 145 is equal to 17 MM, and the second distance 149 is ranged between 17.05 MM and 17.30 MM. The first radius 132 has a value one fifth of that of the first distance 145. The first angle 1491 is equal to 106. Thus, the first distance 145, the second distance 149, and the first radius 132 have numerical relationship, and the first angle 1491 has a preset value. In fabrication, the mounting element 11 has at least twenty Metric specifications and at least twenty British specifications so that it takes too much time to design the various sizes and specifications of the mounting element 11. In the socket structure of the present invention, the first distance 145, the second distance 149, and the first radius 132 have numerical relationship and form mathematic expressions which are built and calculated in the software. In such a manner, after the value of the first distance 145 is designed and finished, the values of the second distance 149 and the first radius 132 are also determined immediately, without having to design and calculate the variables of each of the specifications of the mounting element 11, thereby greatly decreasing the cost of fabrication. Preferably, the maximum and the minimum of the first distance 145 are added and are divided by two to obtain the second distance 149.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A socket structure comprising:
a main body;
wherein:
the main body is provided with a mounting element;
the mounting element includes six drive portions and six receiving portions;
the six drive portions and the six receiving portions are arranged alternately and annularly;
each of the six drive portions includes a first face and a second face;
the first face and the second face have an intersection provided with a first intersecting line;
the first face and the second face intersect at a straight line;
each of the six drive portions is provided with a groove disposed on the first face;
the groove has a first side and two second sides;
the first side and the two second sides form a U-shaped opening;
each of the first side and the two second sides has a planar shape;
the first side is provided on a bottom of the groove;
the two second sides are at two sides of the first side;
one of the two second sides coincides with the first intersecting line;
the groove and the first side have an intersection provided with a second intersecting line;
the groove and each of the six drive portions intersect at the first intersecting line and the second intersecting line;
the second intersecting line is parallel with the first intersecting line;
each of the six receiving portions is an arcuate concave face;
each of the six receiving portions is arranged between the first face of one of the six drive portions and the second face of another one of the six drive portions;
each of the six receiving portions is formed with a first arc;
the first arc is not tangent to the first face and the second face;
the first arc has a first radius;
in a two-dimensional view, the mounting element has an axis provided with a first center which constructs a first circle;
the first face of each of the six drive portions is tangent to the first circle;
the first circle forms a first hexagon having six sides;
the first face of each of the six drive portions coincides with each of the six sides of the first hexagon;
the first center is provided with a first vertical line;
the first face, the groove, and the first intersecting line are arranged at a first side of the first vertical line, and the second face is arranged at a second side of the first vertical line;
the first face is perpendicular to the first vertical line;
the first hexagon has six first angled corners;
the first arc of each of the six receiving portions is situated outside of each of the six first angled corners;
a first distance is defined between two of the six sides of the first hexagon;
in a two-dimensional view, the first center constructs a second circle having a diameter slightly more than that of the first circle;
the second face of each of the six drive portions is tangent to the second circle;
the second circle forms a second hexagon having six sides;
the second face of each of the six drive portions coincides with each of the six sides of the second hexagon;
the second hexagon is larger than the first hexagon;
the second hexagon has six second angled corners;
the first arc of each of the six receiving portions is situated outside of each of the second angled corners;
each of the six first angled corners and each of the second angled corners are disposed in the first arc of each of the six receiving portions;
a second distance is defined between two of the six sides of the second hexagon;
the second distance is more than the first distance; and
a first angle is defined between each of the six sides of the first hexagon and each of the six sides of the second hexagon.

2. The socket structure as claimed in claim 1, wherein the main body is a box end wrench or a socket of a hand operated tool.

3. The socket structure as claimed in claim 1, wherein the first radius has a value one fifth of that of the first distance.

4. The socket structure as claimed in claim 1, wherein the first angle is ranged between 5° and 25° or ranged between 5° and 15°. The first angle is equal to 10°.

5. The socket structure as claimed in claim 1, wherein:
according to a German DIN standard specification, the first distance is equal to or close to an integer value of a specification of the mounting element;
if the specification of the mounting element is 17 MM, the first distance is equal to or close to 17 MM;
according to the German DIN standard specification, the second distance is ranged between an upper limit and a lower limit of the specification of the mounting element;
if the specification of the mounting element is 17 MM, the second distance is ranged between 17.05 MM and 17.30 MM; and
if the specification of the mounting element is 19 MM, the second distance is ranged between 19.06 MM and 19.36 MM.

6. The socket structure as claimed in claim 1, wherein:
the main body is used to operate and rotate a screw member having six sides and six angled corners;
the screw member is worn out and rounded;
when the main body is rotated counterclockwise to drive the screw member, the first intersecting line of each of the six drive portions presses each of the six sides of the screw member; and
the first intersecting line of each of the six drive portions has a line contact with each of the six sides of the screw member so that the first intersecting line of each of the six drive portions concentrates a force point to drive and rotate each of the six worn sides of the screw member.

7. The socket structure as claimed in claim 1, wherein the main body is a ratchet wheel structure pivotally mounted on a ratchet wrench or the main body is a socket.

8. The socket structure as claimed in claim 1, wherein the main body is an open wrench having four drive portions and four receiving portions, and the four drive portions and the four receiving portions are formed on four faces of the mounting element.

9. The socket structure as claimed in claim 1, wherein the main body is an open wrench having two drive portions and two receiving portions, and the two drive portions and the two receiving portions are formed on two faces of the mounting element.

10. The socket structure as claimed in claim 1, wherein the groove has a triangular shape or the groove is an isosceles triangle.

11. The socket structure as claimed in claim 1, wherein:
each of the six drive portions is provided with two grooves connecting each other, each of the two grooves has a first axis, the first axis has a first diameter; or
each of the six drive portions is provided with multiple grooves connecting each other.

12. The socket structure as claimed in claim 1, wherein:
the mounting element includes three drive portions, six receiving portions, and three convex portions;
the three drive portions and the three convex portions are arranged alternately and annularly; and
the three drive portions, the six receiving portions, and the three convex portions are arranged alternately and annularly.

13. The socket structure as claimed in claim 1, wherein each of the six drive portions is provided with two or multiple grooves spaced from each other.

14. The socket structure as claimed in claim 1, wherein:
each of the six drive portions is provided with two grooves spaced from each other;
in three of the six drive portions, the two grooves are formed on the first face; and
in the other three of the six drive portions, one of the two grooves is formed on the first face, and the other one of the two grooves is formed on the second face.

15. The socket structure as claimed in claim 1, wherein the six receiving portions receive six lugs of a star-shaped screw member.
